(19) United States
(12) Patent Application Publication
(10) Pub. No.: US 2019/0315993 A1
(43) Pub. Date: Oct. 17, 2019

(54) FLUOROPOLYMER BASED POWDER COATING

(71) Applicant: ARKEMA FRANCE, COLOMBES (FR)

(72) Inventors: Florent ABGRALL, BERNAY (FR); Anthony BONNET, SAINT-LAURENT-DE-MURE (FR); Samuel DEVISME, ROUEN (FR); Thomas FINE, Shanghai (CN); Takehiro FUKUYAMA, Osaka (JP)

(21) Appl. No.: 16/469,749

(22) PCT Filed: Dec. 14, 2017
(86) PCT No.: PCT/EP2017/082859

§ 371 Date: Jun. 14, 2019

(30) Foreign Application Priority Data
Dec. 20, 2016 (FR) 1662883

(51) Int. Cl. C09D 127/16; B05D 1/06; C08L 33/12; C08K 3/013; C08K 3/22; C09D 5/03; B05D 7/14; B05D 3/02; B05D 3/12

(52) U.S. Cl. CPC C09D 127/16; B05D 1/06; C08L 33/12; C08K 3/013; C08K 3/22; C09D 5/035; B05D 2202/25; B05D 7/14; B05D 3/0254; B05D 3/12; B05D 2506/10; B05D 2502/00; C08K 2003/2241; C09D 5/031

(57) ABSTRACT

The invention relates to fluorinated-acrylic thermoplastic compositions, to powder coatings made of such compositions, and to a process for preparing said powder coatings.

### INVENTION AREA

The invention relates to fluorinated-acrylic thermoplastic compositions, to powder coatings made of such compositions, and to a process for preparing said powder coatings.

### BACKGROUND OF THE INVENTION

Typical thermoplastic fluoropolymer powder coatings are characterized by degrees of mechanical performance and surface roughness or “orange peel” associated with the finish. “Orange peel” may be reduced through various approaches. While the resin melt viscosity may be reduced in order to combat orange peel, melt viscosity reduction generally has an adverse effect on the mechanical properties of the coating, particularly impact resistance, flexibility, and crack resistance.

Powder coatings of polyvinylidene fluoride (PVDF) and copolymers of vinylidene fluoride (VDF) containing at least 90 wt. % VDF are disclosed in U.S. Pat. No. 4,770,939. The PVDF-based resin disclosed in the aforesaid patent for powder coatings has a melt viscosity according to ASTM D3835 of 6 to 7 kilopoise at 230° C. A minor amount of a low molecular weight acrylic polymer is required as a flow improving agent.

Document U.S. Pat. No. 5,177,150 discloses powder coatings formulated from PVDF characterized by melt viscosity as low as from 1 to 4 kilopoise, claiming that the inclusion of flow-improving agents is thus unnecessary. However, the powder coating composition needs cryogenic grinding to obtain small particle size powders (20 μm or less) at high output.

Thus, there exists a need to develop powder coating compositions that present good mechanical properties and weathering resistance, without the use of flow improving agents, and by means of a simplified manufacturing process that no longer needs to use liquid nitrogen for the grounding step. It has now been found that by using compositions made of fluorinated polymers having a melt viscosity under 1 kilopoise and acrylic polymers, powder coatings can be efficiently grounded at room temperature, while showing good mechanical properties and excellent weather resistance.

### SUMMARY OF THE INVENTION

The invention relates first to a composition consisting of:
a. 50-95 weight % of a thermoplastic fluoropolymer, and
b. 5-50 weight % of an acrylic polymer,
   wherein the fluoropolymer has a melt viscosity of from 0.04 to below 1 kilopoise (kP) measured at 100 sec⁻¹ and 230° C. by using ASTM D3835.

Another subject matter of the invention is a powder coating composition comprising the composition described above, at least a pigment and optionally some additives selected from UV absorbers, light stabilizers, matting agents, leveling agents, degassing agents, flowing agents, wetting agents, and impact modifiers.

Another subject matter of the invention is a process for preparing a powder coating using the powder coating composition of the invention.

Another subject matter of the invention is a coating obtained from the curing of at least one powder coating composition according to the invention.

### DETAILED DESCRIPTION OF THE INVENTION

The invention is now described in more detail and without implied limitation in the description which follows.

The invention relates first to a composition consisting of:

a. 50-95 weight % of a thermoplastic fluoropolymer, and

b. 5-50 weight % of an acrylic polymer,

wherein the fluoropolymer has a melt viscosity of from 0.04 to below 1 kilopoise measured at 100 sec⁻¹ and 230° C. by using ASTM D3835.

The term fluoropolymer thus denotes any polymer or blend of polymers that has in its chain at least one monomer chosen from molecules containing a vinyl group capable of opening in order to be polymerized and that contains, directly attached to this vinyl group, at least one fluorine atom, at least one fluoroalkyl group or at least one fluoroalkoxy group.

As examples of monomers, mention may be made of vinyl fluoride; vinylidene fluoride (VDF); trifluoroethylene (VF3); chlorotrifluoroethylene (CTFE); 1,2-difluoroethylene; tetrafluoroethylene (TFE); hexafluoropropylene (HFP); perfluoro(alkyl vinyl) ethers, such as perfluoro(methyl vinyl) ether (PMVE), perfluoro(ethyl vinyl) ether (PEVE) and perfluoro(propyl vinyl) ether (PPVE); perfluoro(1,3-dioxole); perfluoro(2,2-dimethyl-1,3-dioxole) (PDD); the product of formula CF₂═CFOCF₂CF(CF₃)OCF₂CF₂X in which X is SO₂F, CO₂H, CH₂OH, CH₂OCN or CH₂OPO₃H; the product of formula CF₂═CFOCF₂CF₂SO₂F; the product of formula F(CF₂)nCH₂OCF═CF₂ in which n is 1, 2, 3, 4 or 5; the product of formula R₁CH₂OCF═CF₂ in which R₁ is hydrogen or F(CF₂)z and z is 1, 2, 3 or 4; the product of formula R₃OCF═CH₂ in which R₃ is F(CF₂)z- and z is 1, 2, 3 or 4; perfluorobutylethylene (PFBE); 3,3,3-trifluoropropene and 2-trifluoromethyl-3,3,3-trifluoro-1-propene.

The fluoropolymer may be a homopolymer or a copolymer; it may also contain non-fluorinated monomers such as ethylene.

For example, the fluoropolymer is chosen from:
homopolymers and copolymers of vinylidene fluoride (VDF) preferably containing at least 50% by weight of VDF, the comonomer being chosen from chlorotrifluoroethylene (CTFE), hexafluoropropylene (HFP), trifluoroethylene (VF3) and tetrafluoroethylene (TFE);
homopolymers and copolymers of trifluoroethylene (VF3); and
copolymers, and especially terpolymers, that combine the residues of the chlorotrifluoroethylene (CTFE), tetrafluoroethylene (TFE), hexafluoropropylene (HFP) and/or ethylene units and optionally VDF and/or VF3 units.

Advantageously, the fluoropolymer is polyvinylidene fluoride (PVDF) homopolymer or copolymer. Preferably, the PVDF contains at least 50%, more preferably at least 75% and even better at least 85% VDF by weight. In one embodiment, the comonomer is HFP. In another embodiment, the comonomer is TFE.

Characteristically, the fluoropolymer has a viscosity ranging from 0.04 to less than 1 kilopoise, measured at 100 sec⁻¹ and 230° C. by using ASTM D3835.

The term “acrylic polymer” denotes homopolymers of methyl methacrylate or copolymers of methyl methacrylate (MMA) and at least one other monomer copolymerizable with MMA, these copolymers containing at least 50% MMA by weight. As examples of comonomers copolymerizable with MMA, mention may be made of alkyl (meth)acrylates, itaconic acid, (meth)acrylonitrile, vinyl versatate, butadiene, styrene and isoprene. Advantageously, the acrylic polymer contains, by weight, preferably 5 to 15% of a C1-C20 alkyl (meth)acrylate, which is preferably methyl acrylate and/or ethyl acrylate. The acrylic polymer may also be functionalized; that is to say the copolymer contains units of MMA and a second comonomer of general form:

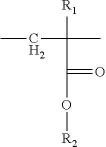

in which:

R₁ denotes H or —CH3;

R₂ denotes H, or a linear or branched alkyl containing from 1 to 20 carbon atoms with functional groups attached. Examples of such functional groups, which in most instances contain heteroatoms (atoms that are neither carbon nor hydrogen), include carboxylic acids, sulfonic or sulfuric acids, phosphonic or phosphoric acids, hydroxyl groups, esters, ketones, ketoesters, amides, urethanes, thiols, siloxanes, fluoroalkyls, acetoacetates, oxiranes; also vinylically unsaturated groups such as vinyl esters or ethers, allyl esters or ethers, acetylenic groups, dienes, malonates, etc.

Especially advantageous are acrylic copolymers containing 0.5-20% by weight of an acid functional monomer or its anhydride derivatives, for instance:

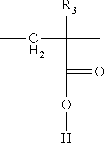

in which:

R₃ denotes H or methyl; or for anhydride derivatives, structures of the form:

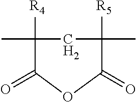

in which R₄ and R₅, which are identical or different, denote H or methyl. The proportion of functional comonomers may be from 0 to 25% by weight, preferably from 5 to 20% of the acrylic polymer including the possible functional groups.

According to a second subject matter, the invention relates to a powder coating composition comprising the thermoplastic composition described above, at least a pigment and optionally some additives selected from UV absorbers, light stabilizers, matting agents, leveling agents, degassing agents, flowing agents, wetting agents, and impact modifiers.

The powder coating composition contains one or more pigments. The pigment may be organic or inorganic. According to one embodiment, the pigment component may comprise titanium dioxide, or titanium dioxide in combination with one or more other inorganic pigments wherein titanium dioxide comprises the major part of the combination. Inorganic pigments which may be used alone or in combination with titanium dioxide include, for example, silica; iron oxides of various colors; lead titanate; and various silicates, for example, talc, diatomaceous earth asbestos, mica, clay and basic lead silicate. Pigments which may be used in combination with titanium dioxide include, for example, zinc oxide, zinc sulfide, zirconium oxide, white lead, carbon black, lead chromate, leafing and non-leafing metallic pigments, molybdate orange, calcium carbonate and barium sulfate. The pigment component is advantageously present in the powder coating composition in the amount of from about 5 to about 30 parts by weight.

The powder coating composition may contain one or more additives which are not pigments. Example of these additives are UV absorbers, light stabilizers, matting agents, leveling agents, degassing agents, flowing agents, wetting agents, and impact modifiers.

Any of the additives contained in the powder coating may be organic or inorganic. They can be used one type alone or in combination of two or more types. Some examples of UV absorbers include, benzotriazoles, oxalic acid diarylamides, and 2-hydroxy benzophenone. Suitable light stabilizers include, for example, hindered amines, such as poly(alkanoyl piperidine alcohols), e.g. oligomers of dimethyl succinate with 4-hydroxy tetramethyl piperidine ethanol, hindered phenols, or combinations thereof. Some examples of matting agents include silica and wax. Examples of leveling agents include copolymer of VDF and HFP with melting point lower than 130° C., ester gum, and silicon oil. Examples of degassing agents include benzoin. Example of the flowing agents include silica and fumed alumina. Silica can also be used as wetting agent. The impact modifier can be preferably of a core-shell type.

The powder coating composition consists of particles having an average size ranging from 10 to 50 μm, preferably from 15 to 30 μm.

Another subject matter of the invention is a process for preparing a powder coating using the powder coating composition of the invention, said process comprising the steps of:
i. preparing a mixture of the thermoplastic fluoropolymer, acrylic polymer, pigment and optionally additives by blending these components then pelletizing or sheet extruding the mixture;
ii. grinding the pellets thus obtained in a hammer mill at room temperature to obtain a powder;
iii. collecting the powder by using a sieve with an opening of 50 μm;
iv. applying the powder to a substrate then subject it to a heat treatment in order to form a coating.

The powder coating composition of fluoropolymer, acrylic resin and pigment is melt-mixed by extrusion, such as in a twin-screw extruder operating in the range of from 160° C. to 210° C. The extruded mixture is thereafter pelletized or extruded into sheets by conventional techniques.

In the next step, the pellets are ground into a powder according to conventional techniques, preferably by using a hammer mill. The resulting raw powder is classified to the desired particle size by passage through the appropriately sized sieve, ranging from 10 to 100 μm, preferably from 15 to 80 μm, more preferably from 15 to 30 μm.

The powder coatings according to the invention can be efficiently ground to particles with average size of 10 to 50 μm at room temperature without the use of cryogenic techniques of grinding. This allows to have an easier handling of the pellets, and ensures lower cost of the global process.

The resulting powder is then applied to a substrate according to any means suitable for obtaining an even distribution of powder. Electrostatic application is the preferred method of application, at an electrical voltage comprised between 25 and 100 V.

The substrate is selected from metals such as iron, aluminum, and manganese and is preferably made of aluminum. The surface of aluminum substrates may be oxidized or chemically treated, but is preferably chromated to have optimum adhesion with the powder coating according to the invention. The substrate can be coated with a primer such an epoxy type resin, prior to coating by the fluoropolymer powder coating.

Following application, the powder coating is subjected to a heat treatment sufficient to melt the powder coating. The temperature used should be higher than the melting point of the powder.

In one embodiment, the coating is baked at a temperature comprised between 220 and 260° C. for a duration comprised between 5 to 20 minutes. The coating and its substrate are thereafter cooled by any suitable means.

In another embodiment, the heat treatment consists in immersing the coated substrate in boiling water for 4 to 6 hours.

Another subject of the present invention is a substrate coated with a coating as defined above according to the present invention. The coating thickness is preferably, but not limited to, 30˜1000 μm. The substrate may be used in applications such as curtain walls of high rise buildings, traffic signage, and outdoor units of air conditioners.

### EXAMPLES

### Example 1

52.5 wt % of PVDF homopolymer having a melt viscosity of 0.2 kP measured at 100 sec⁻¹, 230° C. according to ASTM D3835 is added to 22.5 wt % of PMMA resin comprising of 90:10 methylmethacrylate and glutaric anhydride copolymer. Also added to the mixture is 25 wt % of TiO2. The mixture is blended in a twin screw mixer operating at a range of 160° C. to 210° C., and pelletized. The pellets are directly grinded in a hammer mill at room temperature. The particle size distribution of the resulting powder is measured by Microtrac 3000 apparatus with water as the media. The powder is electrostatically applied at 50 kV onto a substrate of chromated aluminum. The panels are then baked at 250° C. for 15 minutes.

The coated panels are evaluated by the methods indicated below in Table 1.

TABLE 1

| Characterization | Result | Method |
|---|---|---|
| Adhesion | 100/100 | ASTM D3359 |
| Boiling water | 100/100 | Immerse coated panel in |
| adhesion | | boiling water for 5 hours then |
| | | test under ASTM D3359 |
| Weathering | >80% gloss | Age coating by QUV-B |
| | retention | under ASTM G53 for 1000 |
| | | hours and measure 60 degree |
| | | gloss according to ASTM |
| | | D523. Compare against |
| | | initial gloss |

### Example 2

Same procedure in as example 1 except for the composition of the fluoropolymer. 47.5 wt % of the formulation remain PVDF homopolymer having a melt viscosity of 0.2 kP measured at 100 sec⁻¹, 230° C. according to ASTM D3835 and 5 wt % is replaced with a VDF/HFP copolymer having a melt viscosity of 25 kP measured at 100 sec⁻¹, 230° C. according to ASTM D3835. The global viscosity of the fluoropolymer phase is 0.9 kP (measured at 100 sec⁻¹, 230° C. according to ASTM D3835).

### Comparative Example 3

Same procedure as in example 1 was used, except for the PVDF homopolymer which has a melt viscosity of 6 kP measured at 100 sec⁻¹, 230° C. according to ASTM D3835 instead of the 0.2 kP PVDF homopolymer, and a copolymer of MMA and ethyl acrylate was used in place of the MMA/glutaric anhydride 90/10 acrylic copolymer.

### Comparative Example 4

Same procedure as in example 1 was used, except for the PVDF homopolymer which has a melt viscosity of 3.5 kP measured at 100 sec⁻¹, 230° C. according to ASTM D3835 instead of the 0.2 kP PVDF homopolymer.

Evaluation results are given in Table 2.

TABLE 2

| | | | | Comp. | Comp. |
|---|---|---|---|---|---|
| | | Ex. 1 | Ex. 2 | ex. 3 | ex. 4 |
| Adhesion | | Pass | Pass | Fail | Pass |
| Boiling water | | Pass | Pass | Fail | Fail |
| adhesion | | | | | |
| Weathering | | Pass | Pass | Pass | Pass |
| <50 | μm | 27% | 26% | 10% | 7% |
| 50~100 | μm | 57% | 56% | 50% | 55% |
| >100 | μm | 16% | 18% | 40% | 38% |

These data show that fluoropolymer viscosities below to 1 kP (as in examples 1 & 2) allows better grindability vs comparative examples 3 and 4. Low particle size can be achieved with a grinding process at room temperature which is a major advantage in term of grinding cost and productivity. It is interesting to notice that the main applicative properties for a coating remain achieved with the compositions of examples 1 and 2.

1. A composition consisting of:
a. 50-95 weight % of one or more thermoplastic fluoropolymers, and
b. 5-50 weight % of an acrylic polymer,
wherein the fluoropolymer has a melt viscosity of from 0.04 to below 1 kP measured at 100 sec⁻¹ and 230° C. by using ASTM D3835.

2. The composition of claim 1 wherein at least one thermoplastic fluoropolymer is selected from the group consisting of: homopolymers of vinylidene fluoride (VDF); copolymers of vinylidene fluoride (VDF) containing at least 50% by weight of VDF, wherein at least one comonomer of the VDF copolymer is selected from the group consisting of chlorotrifluoroethylene, hexafluoropropylene, trifluoroethylene and tetrafluoroethylene; homopolymers of trifluoroethylene; copolymers of trifluoroethylene; and copolymers comprising the residues of at least 2 of chlorotrifluoroethylene, tetrafluoroethylene, hexafluoropropylene, ethylene units and optionally VDF and/or trifluoroethylene units.

3. The composition of claim 1 wherein the fluoropolymer is selected from the group consisting of polyvinylidene fluoride (PVDF) homopolymer or a copolymer of vinylidene fluoride with hexafluoropropylene or a copolymer of vinylidene fluoride with tetrafluoroethylene.

4. The composition of claim 1 wherein said acrylic polymer is a homopolymer of methylmethacrylate (MMA) or a copolymer of methylmethacrylate and at least one other monomer copolymerizable with MMA, wherein the copolymer of methylmethacrylate (MMA) contains at least 50% MMA by weight.

5. A powder coating composition comprising the composition of claim 1, wherein said composition further comprises from 5 to 30% by weight of one or more pigments and optionally additives.

6. The powder coating composition of claim 5 wherein at least one pigment is selected from the group consisting of titanium dioxide, iron oxides, lead titanate, and silicates.

7. The powder coating composition of claim 5, wherein said composition further comprises at least one additive selected from the group consisting of UV absorbers, light stabilizers, matting agents, leveling agents, degassing agents, flowing agents, wetting agents, and impact modifiers.

8. The powder coating composition of claim 5, wherein said composition comprises particles having an average size ranging from 10 to 100 μm.

9. A process for preparing a powder coating using the powder coating composition of claim 5, said process comprising the steps of:
i. Preparing a mixture comprising the thermoplastic fluoropolymer, acrylic polymer, pigment and optionally additives by blending these components and then pelletizing or sheet extruding the mixture;
ii. grinding the pellets thus obtained in a hammer mill at room temperature to obtain a powder;
iii. collecting the powder by using a sieve with an opening of 50 μm;
iv. applying the powder to a substrate and then subjecting the powdered substrate to a heat treatment forming a coating.

10. The process of claim 9 wherein the powder is electrostatically applied to said substrate at an electrical voltage comprised between 25 and 100 V.

11. The process of claim 8, wherein the substrate is made of aluminum or chromated aluminum.

12. The process of claim 9, wherein the heat treatment comprises baking the coated substrate at a temperature comprised between 220 and 260° C. for a duration comprised between 5 to 20 minutes.

13. The process of claim 9, wherein the heat treatment comprises immersing the coated substrate in boiling water for 4 to 6 hours.

14. The process of claim 9, wherein the obtained coating has a thickness ranging from 30 to 1000 μm.

15. A coating produced from the curing of the powder coating composition of claim 5.
